(19) United States
(12) Patent Application Publication
(10) Pub. No.: US 2025/0210915 A1
(43) Pub. Date: Jun. 26, 2025

(54) CONNECTOR

(71) Applicant: SUMITOMO WIRING SYSTEMS, LTD., Mie (JP)

(72) Inventors: Kenkichi KAI, Mie (JP); Junya MATSUURA, Mie (JP)

(21) Appl. No.: 18/982,047

(22) Filed: Dec. 16, 2024

(30) Foreign Application Priority Data
Dec. 26, 2023 (JP) 2023-219398

(51) Int. Cl. H01R 13/629

(52) U.S. Cl. CPC H01R 13/62938

(57) ABSTRACT

A connector 10 includes a housing 20 and a lever 60 for connecting operation movable in a sliding direction along a slide surface 23 of the housing 20. The housing 20 includes a lever accommodating portion 26 defining a space for arranging the lever 60 between the slide surface 23 and the lever accommodating portion 26, an opening 31 facing the slide surface 23 at one end of the lever accommodating portion 26, a movement guide portion 32 extending in the sliding direction from the opening 31 at a position separated from the slide surface 23 on an inner surface of the lever accommodating portion 26, and an assembly guide portion 25 projecting from the slide surface 23, extending in the sliding direction and facing the movement guide portion 32 at a position corresponding to the opening 31.

### CROSS-REFERENCE TO RELATED APPLICATIONS

This application is based on and claims priority from Japanese Patent Application No. 2023-219398, filed on Dec. 26, 2023, with the Japan Patent Office, the disclosure of which is incorporated herein in its entirety by reference.

### TECHNICAL FIELD

The present disclosure relates to a connector.

### BACKGROUND

A connector described in Japanese Patent Laid-open Publication No. 2017-157503 is provided with a waiting-side housing (hereinafter, referred to as a housing) and a slide lever (hereinafter, referred to as a lever) slidable along a side surface of the housing between an initial position and a connection position with respect to the housing. The housing includes guide wall portions arranged apart from side surfaces of the housing. The lever includes a pair of guide function portions facing each other and an operating portion coupling the respective guide function portions. The guide function portions are arranged between the side surfaces of the housing and the guide wall portions. By moving the lever from the initial position to the connection position with the guide function portions engaged with a mating fit-in side housing, the housing and the fit-in side housing are connected with a low connection force. A connector provided with a lever (slide lever) of this type is also disclosed in Japanese Patent Laid-open Publication No. 2013-143209

### SUMMARY

In Japanese Patent Laid-open Publication No. 2017-157503, if plate thicknesses of the guide function portions become smaller than gaps between the side surfaces of the housing and the guide wall portions for the structural reason of the lever or the housing, the guide function portions may rattle between the side surfaces of the housing and the guide wall portions to affect a lever moving operation. In contrast, a structure for causing cam portions to slide on movement guide portions can be adopted by providing the movement guide portions between the side surfaces of the housing and the guide wall portions. However, in this case, there is a concern that the cam portions are not directly opposed to the movement guide portions and an assembling operation cannot be smoothly performed when the lever is assembled with the housing.

Accordingly, the present disclosure aims to provide a connector enabling a lever to be assembled with a housing without any trouble.

The present disclosure is directed to a connector with a housing connectable to a mating connector and a lever for connecting operation movable in a sliding direction intersecting a connection direction of the housing and the mating connector along a slide surface of the housing, the housing including a lever accommodating portion defining a space for arranging the lever between the slide surface and the lever accommodating portion, an opening facing the slide surface at one end of the lever accommodating portion, a movement guide portion extending in the sliding direction from the opening at a position separated from the slide surface on an inner surface of the lever accommodating portion, and an assembly guide portion projecting from the slide surface, extending in the sliding direction and facing the movement guide portion at a position corresponding to the opening.

According to the present disclosure, it is possible to provide a connector enabling a lever to be assembled with a housing without any trouble.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is an exploded perspective view showing a frame of a housing and a lever in a connector of one embodiment.

FIG. 2 is a front view of the lever in the connector of the embodiment.

FIG. 3 is a plan view of the lever in the connector of the embodiment.

FIG. 4 is a side view of the frame of the housing in the connector of the embodiment when viewed from right.

FIG. 5 is a perspective view enlargedly showing a state immediately before the assembly of the lever with the housing is started in the connector of the embodiment when viewed from a right upper side.

FIG. 6 is a transverse section enlargedly showing the state immediately before the assembly of the lever with the housing is started in the connector of the embodiment when viewed from behind.

FIG. 7 is a transverse section enlargedly showing a state where a tip part of a cam portion rides over a guide slope and slides on an assembly guide portion in the process of assembling the lever with the housing in the connector of the embodiment when viewed from behind.

FIG. 8 is a transverse section enlargedly showing a state where the tip part of the cam portion is moved to a contact surface from the state of FIG. 7 in the connector of the embodiment when viewed from behind.

FIG. 9 is a transverse section enlargedly showing a state where the lever reaches a complete locking position from the state of FIG. 8 and the cam portion is arranged at a proper depth in a lever accommodating portion in the connector of the embodiment when viewed from behind.

FIG. 10 is a side view in section enlargedly showing a state where the cam portion is arranged inside the lever accommodating portion with the lever located the complete locking position in the connector of the embodiment when viewed from left.

FIG. 11 is a plan view in section showing a state where the lever is held at a temporary locking position with respect to the housing in the connector of the embodiment.

FIG. 12 is a plan view in section showing a state where the lever is held at the complete locking position with respect to the housing in the connector of the embodiment.

### DETAILED DESCRIPTION

In the following detailed description, reference is made to the accompanying drawings, which form a part hereof. The illustrative embodiments described in the detailed description, drawings, and claims are not meant to be limiting. Other embodiments may be utilized, and other changes may be made, without departing from the spirit or scope of the subject matter presented here.

### Description of Embodiments of Present Disclosure

First, embodiments of the present disclosure are listed and described.

(1) The connector of the present disclosure is provided with a housing connectable to a mating connector and a lever for connecting operation movable in a sliding direction intersecting a connection direction of the housing and the mating connector along a slide surface of the housing, the housing including a lever accommodating portion defining a space for arranging the lever between the slide surface and the lever accommodating portion, an opening facing the slide surface at one end of the lever accommodating portion, a movement guide portion extending in the sliding direction from the opening at a position separated from the slide surface on an inner surface of the lever accommodating portion, and an assembly guide portion projecting from the slide surface, extending in the sliding direction and facing the movement guide portion at a position corresponding to the opening.

According to the configuration of (1) described above, the lever can be automatically brought to a position engageable with the movement guide portion by being slid along the assembly guide portion when the lever is assembled with the housing.

(2) Preferably, in the connector of (1) described above, the assembly guide portion extends in the sliding direction inside and outside the lever accommodating portion via the opening.

According to the configuration of (2) described above, a movement stroke of the lever along the assembly guide portion can be ensured to be long, and reliability in bringing the lever to the position engageable with the movement guide portion can be enhanced.

(3) Preferably, in the connector of (1) or (2) described above, the lever includes a pair of cam portions facing each other and extending in the sliding direction and an operating portion coupling the cam portions and reaches a complete locking position with respect to the housing when connection of the housing and the mating connector is completed, and the cam portion is in contact with the slide surface while applying a resilient force at the complete locking position.

According to the configuration of (3) described above, even if the cam portion is deformed to be deflected inward with respect to the operating portion during the molding of the lever, the inward deflection of the cam portion can be corrected by the cam portion contacting the slide surface.

(4) In the connector of (3) described above, the lever may be arranged in proximity to the assembly guide portion in a non-contact state at the complete locking position.

According to the configuration of (4) described above, the assembly guide portion can be provided with good space efficiency at a position (dead space) where interference with the lever can be avoided.

(5) Preferably, in the connector of any one of (1) to (4) described above, the assembly guide portion includes a guide slope inclined toward the movement guide portion from the slide surface and extending in the sliding direction outside the lever accommodating portion.

According to the configuration of (5) described above, reliability in bringing the lever to the position engageable with the movement guide portion can be enhanced by guiding the lever by the guide slope. Further, since the guide slope is located outside the lever accommodating portion and easily processed, the formability (dimensional accuracy) of the guide slope can be enhanced.

### Details of Embodiment of Present Disclosure

A specific example of the present disclosure is described below with reference to the drawings. Note that the present invention is not limited to this illustration, but is represented by claims and intended to include all changes in the scope of claims and in the meaning and scope of equivalents.

### Embodiment

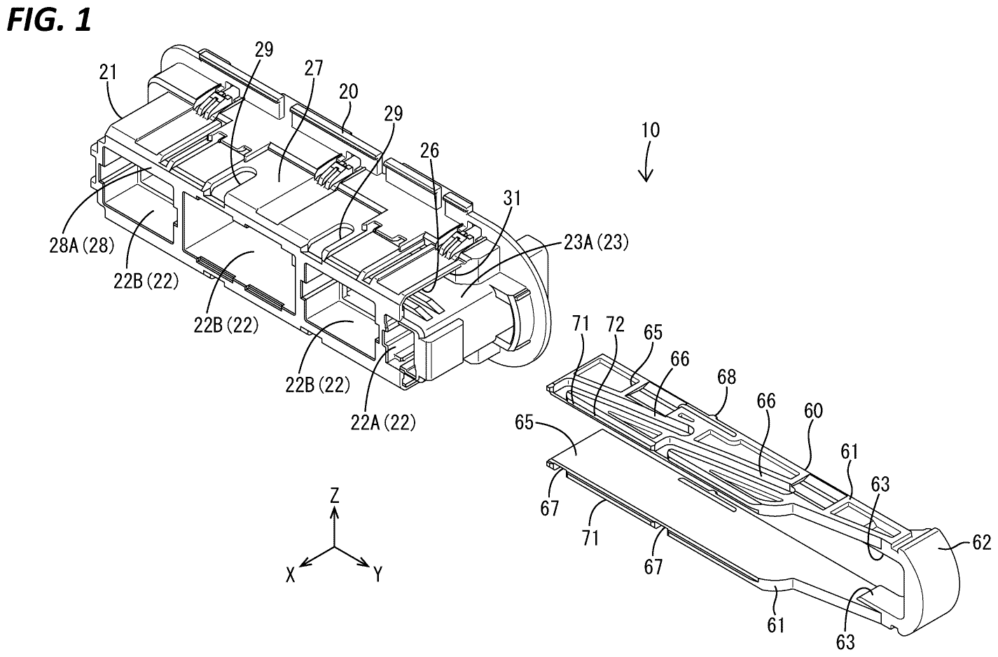

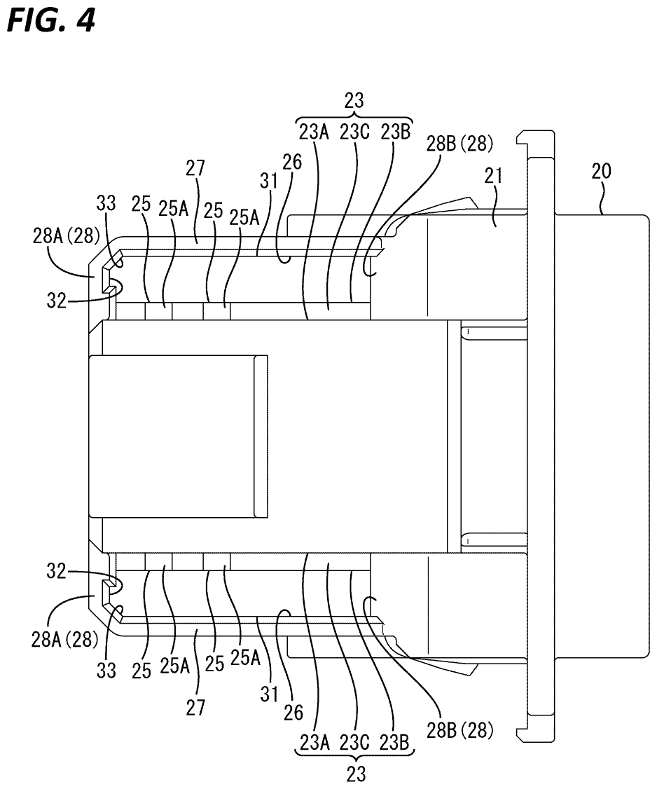

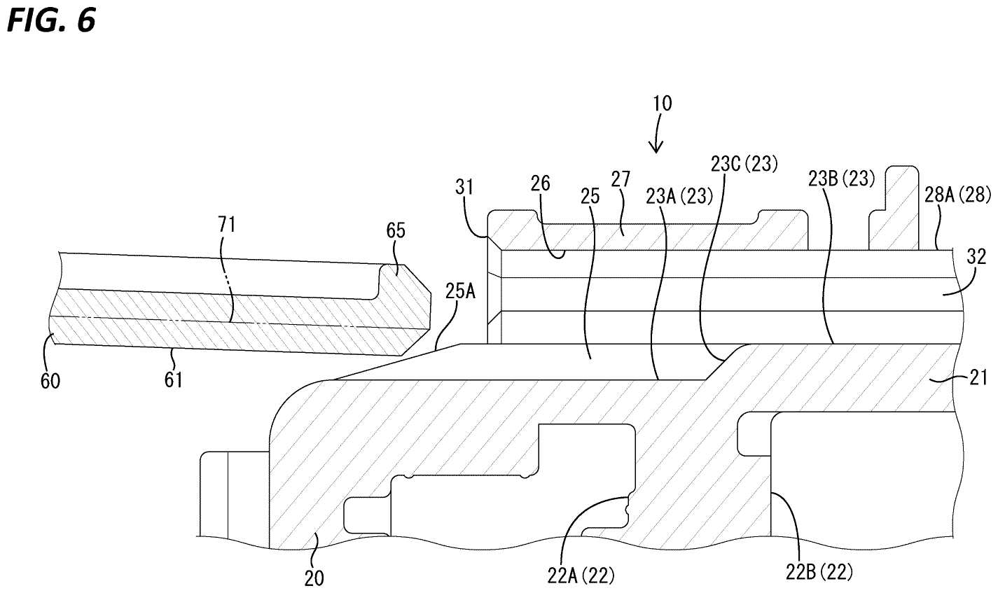

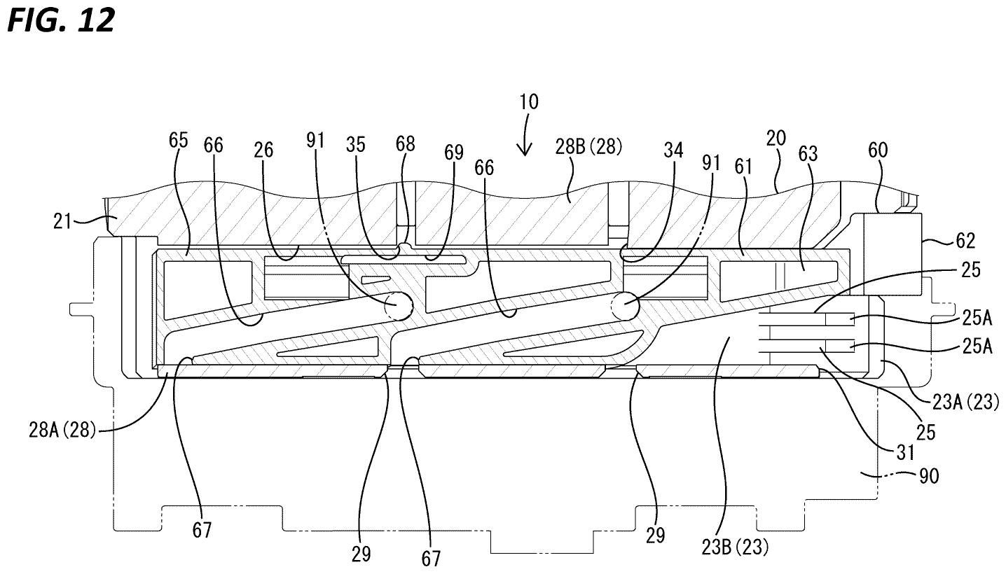

A connector 10 of one embodiment is, as shown in FIG. 1, provided with a housing 20 and a slide-type lever 60 arranged movably between a temporary locking position and a complete locking position with respect to the housing 20. As shown in FIG. 12, the housing 20 is connectable to a mating connector 90. Note that, in the following description, a connection direction of the housing 20 to the mating connector 90 is referred to as a forward direction concerning a front-rear direction. A vertical direction is based on a vertical direction of each figure except FIGS. 4, 11 and 12. A lateral direction is based on a lateral direction of FIGS. 1, 3 to 5, 11 and 12. A lateral direction of FIGS. 6 to 9 is opposite to the lateral direction of FIGS. 1, 3 to 5, 11 and 12. The lateral direction corresponds to a moving direction (sliding direction) of the lever 60 along later-described slide surfaces 23 of the housing 20. In the case of the embodiment, a moving direction of the lever 60 from the temporary locking position to the complete locking position with respect to the housing 20 when the housing 20 and the mating connector 90 are connected is a leftward direction. In contrast, a moving direction of the lever 60 from the complete locking position to the temporary locking position with respect to the housing 20 when the housing 20 and the mating connector 90 are separated is a rightward direction. In FIG. 1, the forward direction is represented by X, the rightward direction is represented by Y and an upward direction is represented by Z. These direction references are for convenience and dot not necessarily coincide with directions in a state where the connector 10 is installed in an unillustrated vehicle or the like.

### Lever 60

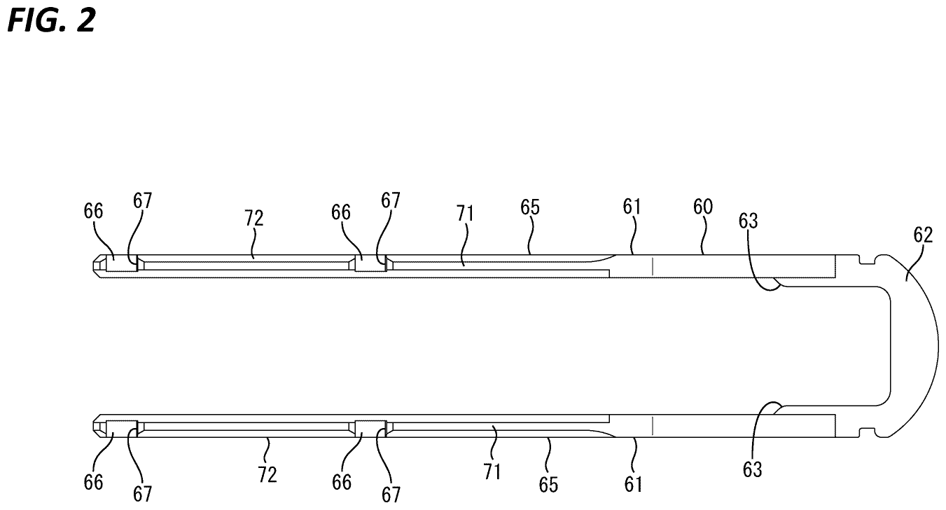

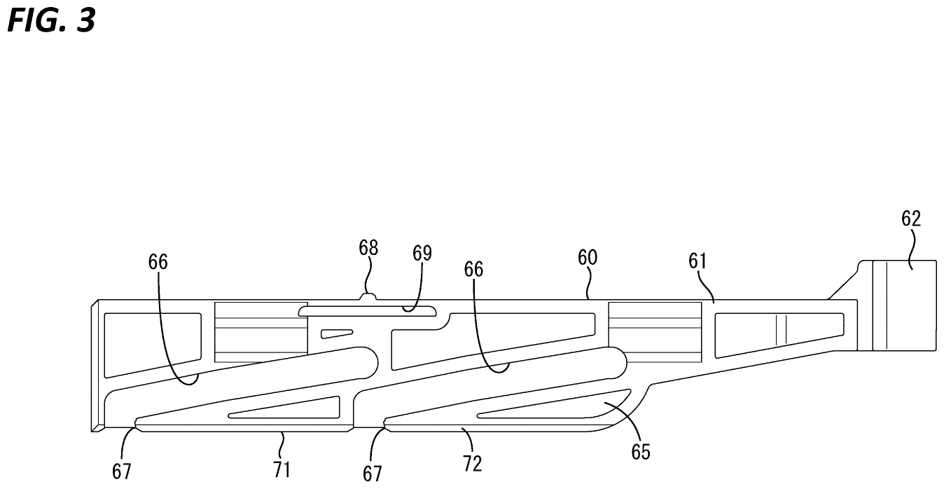

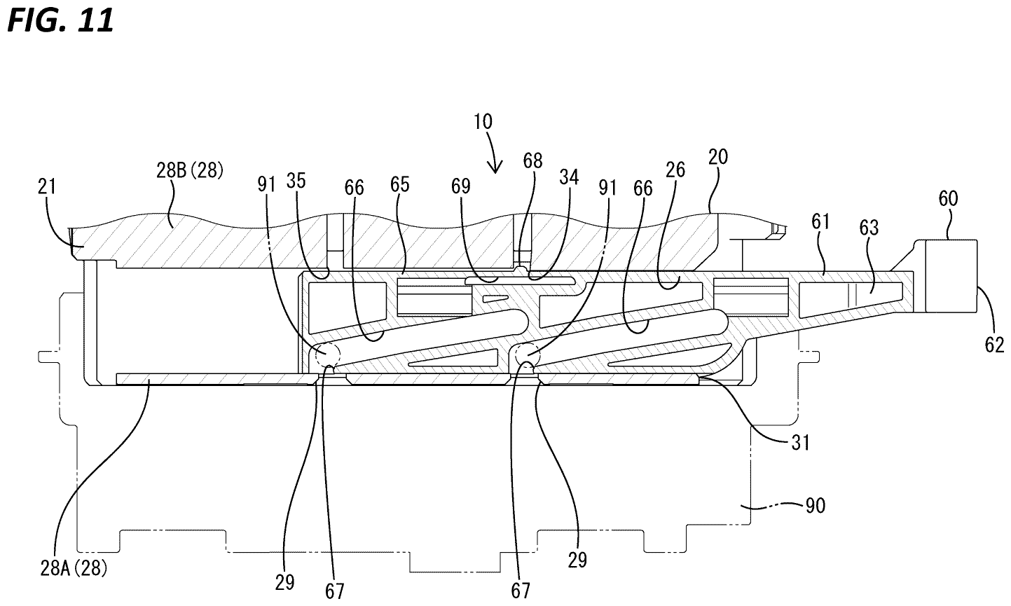

The lever 60 is made of synthetic resin and includes, as shown in FIGS. 1 and 2, a pair of cam portions 61 arranged to face each other in the vertical direction and an operating portion 62 coupling right end parts of the cam portions 61. The operating portion 62 extends in the vertical direction and has a right side surface curved rightward as a whole. Each cam portion 61 is plate-like and has plate surfaces facing in the vertical direction. Each cam portion 61 includes a thick reinforcing portion 63 on a base end part connected to the operating portion 62. A left part of each cam portion 61 is configured as a cam body portion 65 having a part protruding further upward or downward than the base end part. As shown in FIG. 3, a pair of left and right cam grooves 66 are formed in the outer surface (surface facing vertically outward) of the cam body portion 65. The respective cam grooves 66 are arranged at an interval in the lateral direction in the cam body portion 65. Each cam groove 66 has an entrance 67 open in the front end of the cam body portion 65. As shown in FIG. 11, if the housing 20 is lightly fit to the mating connector 90 with the lever 60 arranged at the temporary locking position with respect to the housing 20, cam pins 91 formed on the mating connector 90 enter the entrances 67 of the respective cam grooves 66. In the process of moving the lever 60 from the temporary locking position to the complete locking position, the respective cam pins 91 slide on groove surfaces of the respective cam grooves 66 and the connection of the housing 20 and the mating connector 90 proceeds with a low connection force. If the lever 60 reaches the complete locking position with respect to the housing 20 as shown in FIG. 12, the respective cam pins 91 reach back end sides of the respective cam grooves 66 and the connection of the housing 20 and the mating connector 90 is completed. With the connection of the housing 20 and the mating connector 90 completed, terminal fittings accommodated in the housing 20 are properly electrically connected to unillustrated mating terminal fittings mounted in the mating connector 90.

As shown in FIG. 3, a locking portion 68 is formed to project on the rear end edge of the cam body portion 65 of each cam portion 61. A slit 69 extending in the lateral direction is formed at a position forward of and near the locking portion 68. Each locking portion 68 is resiliently displaceable in a direction to narrow a width in the front-rear direction of the slit 69. By locking each locking portion 68 to the housing 20, the lever 60 is held at the temporary locking position and the complete locking position with respect to the housing 20.

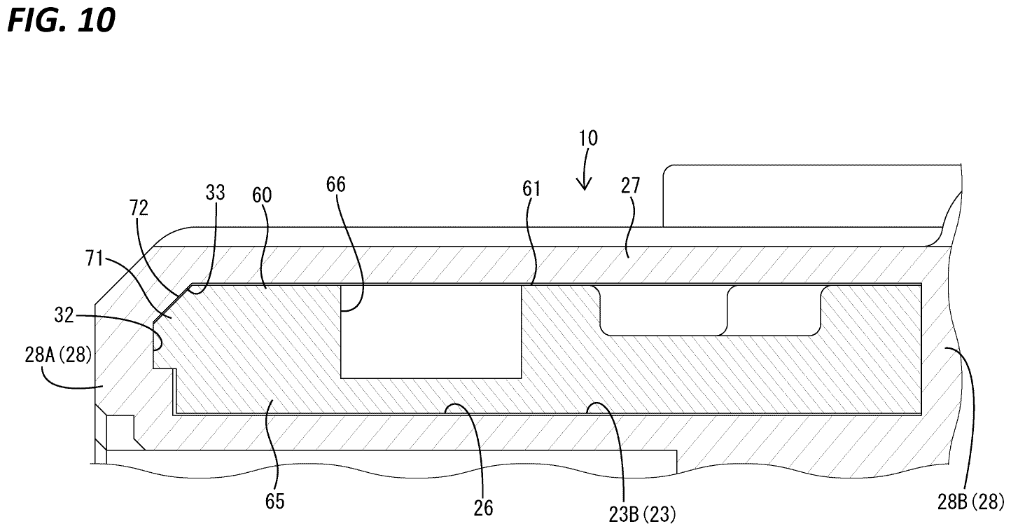

As shown in FIGS. 1 to 3, a moved guide portion 71 is formed on the front end edge of the cam body portion 65 of each cam portion 61. The moved guide portion 71 is in the form of a rib extending in the front-rear direction via the entrances 67 of the cam grooves 66 in a vertically outer part of the front end edge of the cam body portion 65. As shown in FIGS. 2 and 10, a corner part on a vertically outer side of the moved guide portion 71 is chamfered into a C surface 72 over an entire length in the lateral direction.

### Housing 20

The housing 20 is made of synthetic resin and includes, as shown in FIG. 1, a frame 21 long in the lateral direction. The frame 21 is formed with a plurality of fitting portions 22 arranged in the lateral direction. Each fitting portion 22 penetrates through the frame 21 in the front-rear direction. An unillustrated sub-housing is fit and accommodated into each fitting portion 22 of the frame 21. Unillustrated terminal fittings are accommodated into the sub-housing. Out of the fitting portions 22, the rightmost one is configured as a small fitting portion 22A having smaller opening dimensions in the lateral direction and the vertical direction than a plurality of other fitting portions 22B.

As shown in FIG. 4, the slide surfaces 23 are formed on the upper and lower end surfaces of the housing 20. Each cam portion 61 of the lever 60 is slidably (slide-contactably) facing each slide surface 23. Note that, in the case of this embodiment, the slide surface 23 is not limited to the one to be held in contact with the lever 60, but may be displaced along the lever 60 while being spaced apart from the lever 60 like a facing surface 23A to be described later. As shown in FIGS. 6 to 9, the slide surface 23 includes the facing surface 23A formed on a right end part of the frame 21 to correspond to the small fitting portion 22A, a contact surface 23B formed in a part of the frame 21 except the right end part to correspond to the plurality of other fitting portions 22B, and a step surface 23C formed between the facing surface 23A and the contact surface 23B. A lateral length of the contact surface 23B is longer than that of the facing surface 23A. The facing surface 23A and the contact surface 23B are formed to be flat along the lateral direction and the front-rear direction. The contact surface 23B is located vertically outside the facing surface 23A via the step surface 23C. The step surface 23C is inclined leftward with respect to the vertical direction from the contact surface 23B toward the facing surface 23A.

As shown in FIG. 12, when the lever 60 is at the complete locking position, the base end part of the cam portion 61 including the reinforcing portion 63 is arranged to face a rear part of the facing surface 23A. Assembly guide portions 25 are formed to project on a front part of the facing surface 23A. A pair of the assembly guide portions 25 are arranged at an interval in the front-rear direction. As shown in FIGS. 6 to 9, the assembly guide portion 25 extends in the lateral direction and has a left end integrally coupled to the step surface 23C. An end surface on the vertically outer side of each assembly guide portion 25 is continuous in the lateral direction at the same height as the contact surface 23B. The right end surface of each assembly guide portion 25 is configured as a guide slope 25A inclined leftward with respect to the vertical direction toward the vertically outer side. The guide slope 25A is linearly inclined from the contact surface 23B to the end surface on the vertically outer side of each assembly guide portion 25.

Further, as shown in FIGS. 4, 5 and 10, the housing 20 includes a pair of upper and lower lever accommodating portions 26. The cam portions 61 of the lever 60 are arranged between the slide surfaces 23 and the lever accommodating portions 26. The lever accommodating portion 26 includes a facing wall portion 27 facing the slide surface 23 and end wall portions 28 extending short in the vertical direction between the slide surface 23 and the facing wall portion 27 and coupled to front and rear end parts of the facing wall portion 27 and the slide surface 23.

As shown in FIG. 1, the facing wall portion 27 is formed with a pair of introduction grooves 29 at an interval in the lateral direction. Each introduction groove 29 extends in the front-rear direction in the facing wall portion 27 and has a front end open in the front end wall portion 28A. As shown in FIG. 11, when the lever 60 is at the temporary locking position, the entrance 67 of each cam groove 66 communicates with each introduction groove 29. Each cam pin 91 of the mating connector 90 is introduced into the entrance 67 of each cam groove 66 via each introduction groove 29.

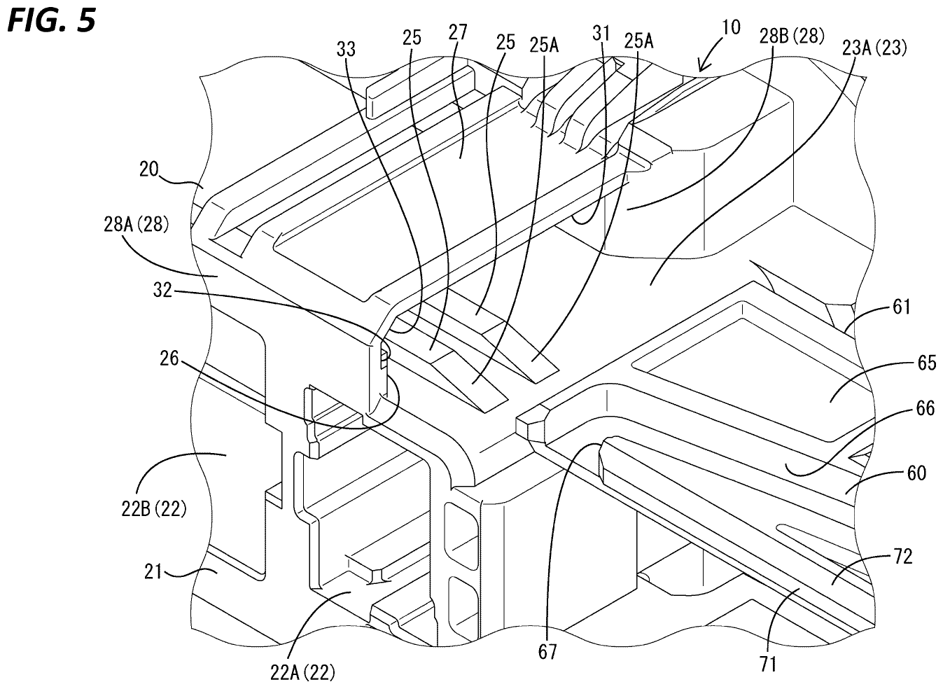

As shown in FIGS. 5 to 9, an opening 31 facing the facing surface 23 A is formed at a halfway position in the lateral direction of the facing surface 23A on the right end of the lever accommodating portion 26. Each assembly guide portion 25 extends in the lateral direction inside and outside the lever accommodating portion 26 via the opening 31.

As shown in FIGS. 4, 5 and 10, a groove-like movement guide portion 32 extending in the front-rear direction is formed in the inner surface (surface facing the rear end wall portion 28B) of the front end wall portion 28A, out of a pair of front and rear end wall portions 28. The movement guide portion 32 is provided by recessing a vertically outer part separated from the slide surface 23 on the inner surface of the front end wall portion 28A. The right end of the movement guide portion 32 communicates with the opening 31. The moved guide portion 71 is slidably fit into the movement guide portion 32. A slope portion 33 corresponding to the C surface 72 of the moved guide portion 71 is formed in the inner surface of the movement guide portion 32.

As shown in FIGS. 11 and 12, a temporary lock receiving portion 34 and a complete lock receiving portion 35 are provided by recessing the inner surface (surface facing the front end wall portion 28A) of the rear end wall portion 28B, out of the front and rear end wall portions 28. The temporary lock receiving portion 34 and the complete lock receiving portion 35 are arranged at an interval in the lateral direction in the inner surface of the rear end wall portion 28B. The temporary lock receiving portion 34 is located to the right of the complete lock receiving portion 35. As shown in FIG. 11, by fitting and locking the locking portions 68 to the temporary lock receiving portions 34, the lever 60 is held in a movement restricted state at the temporary locking position with respect to the housing 20. As shown in FIG. 12, by fitting and locking the locking portions 68 to the complete lock receiving portions 35, the lever 60 is held in a movement restricted state at the complete locking position with respect to the housing 20.

### Functions of Connector 10

In assembling the lever 60 with the housing 20, the lever 60 is arranged to the right of the frame 21 and a tip part (left end part) of the cam body portion 65 of each cam portion 61 is caused to face the opening 31 as shown in FIGS. 1 and 5. In that state, the lever 60 is moved leftward by gripping the operating portion 62. When the assembly of the lever 60 is started, the tip parts of the cam body portions 65 slidably face the facing surfaces 23A of the housing 20.

When the lever 60 is molded, the cam portions 61 may be deformed vertically inward (deflected inward) with respect to the operating portion 62 so that the tip parts of the cam body portions 65 come closer to each other. If the cam portions 61 are deflected inward, the moved guide portions 71 are shifted vertically inward from positions directly opposed to the movement guide portions 32 when the assembly of the lever 60 is started.

As shown in FIG. 6, if the lever 60 is moved toward the lever accommodating portion 26 with the moved guide portion 71 shifted vertically inward of the movement guide portion 32, the tip part of the cam body portion 65 slides along the guide slope 25A of the assembly guide portion 25. As the tip part of the cam body portion 65 is displaced leftward on the guide slope 25A, the cam portion 61 is resiliently deformed vertically outward with the side of the reinforcing portion 63 as a fulcrum. In this way, the moved guide portion 71 is gradually displaced toward the movement guide portion 32 and the inward deflection of the cam portion 62 is corrected. Note that, even if the cam portion 61 is not deflected inward, the tip part of the cam body portion 65 is slidable along the guide slope 25A of each assembly guide portion 25 within a dimensional tolerance range.

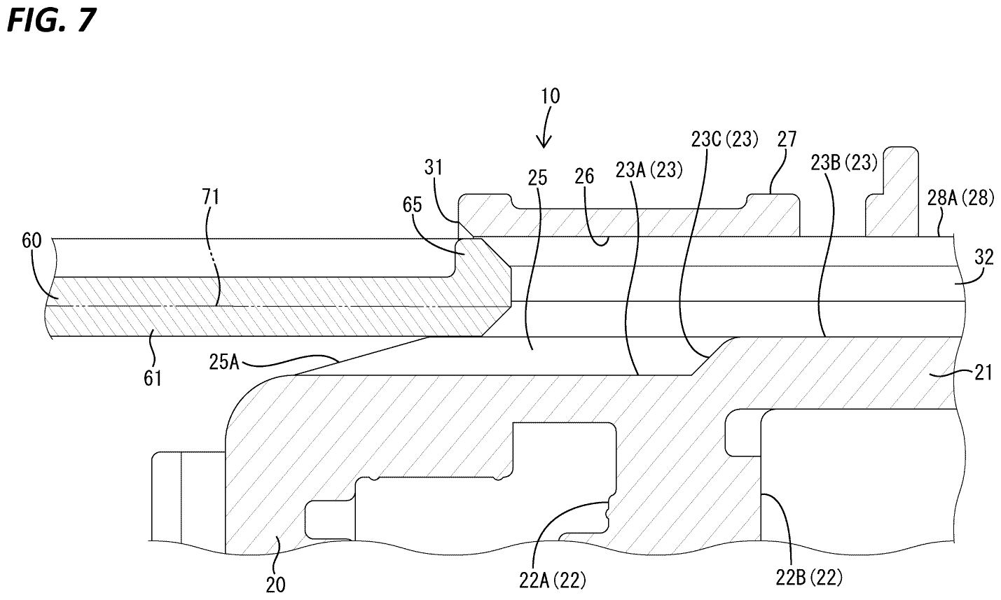

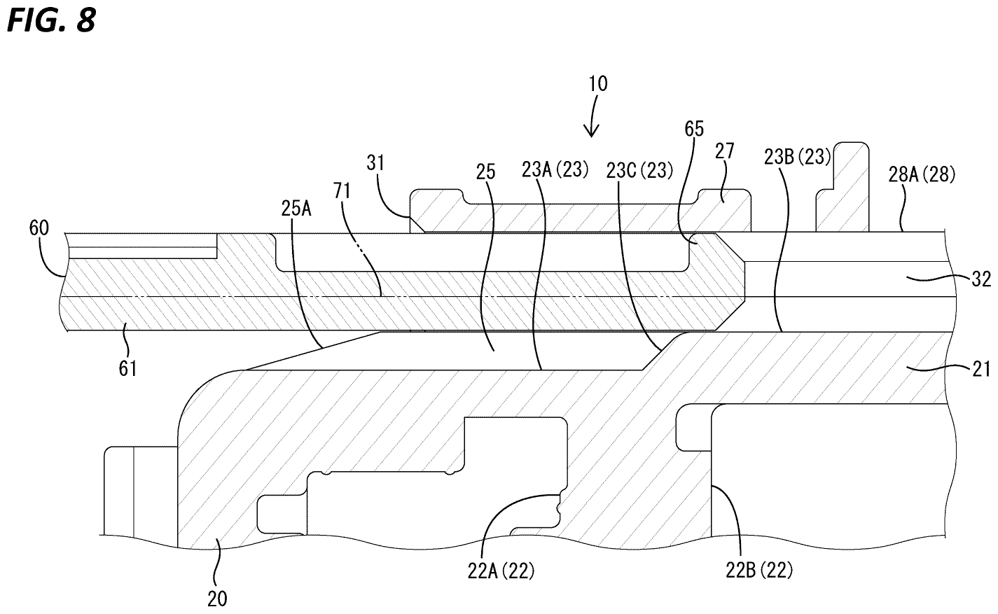

If the tip part of the cam body portion 65 rides over the guide slope 25A as shown in FIG. 7, the moved guide portion 71 is at the same height as the movement guide portion 32 and the moved guide portion 71 is fit to the movement guide portion 32 through the opening 31. If the lever 60 continues to move, the moved guide portion 71 slides along the movement guide portion 32. As shown in FIGS. 7 and 8, the tip part of the cam body portion 65 continuously slides along the contact surface 23B from the end surfaces on the vertically outer sides of the assembly guide portions 25.

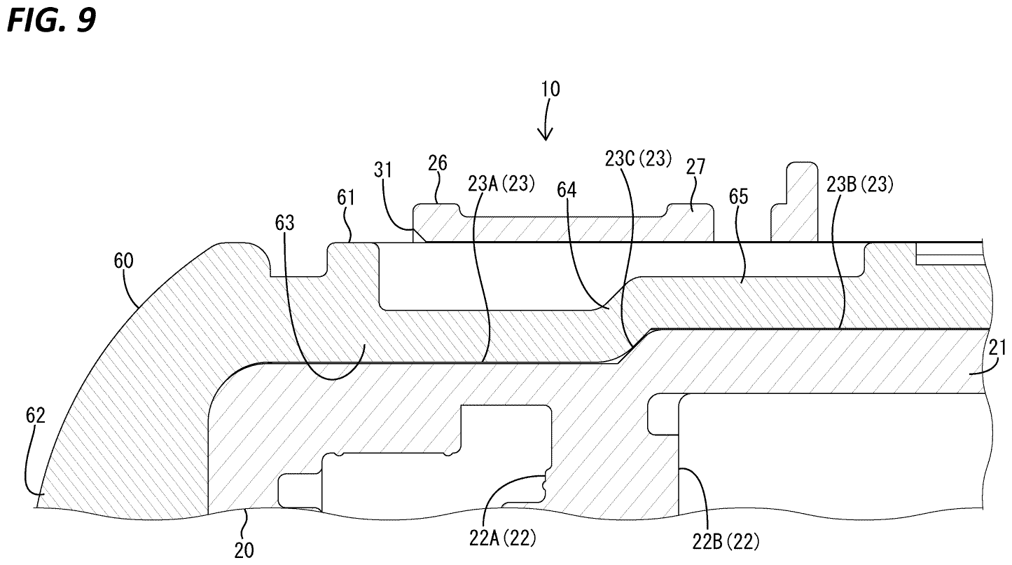

When the lever 60 reaches the temporary locking position, the locking portions 68 are resiliently fit into the temporary lock receiving portions 34 and the assembly of the lever 60 is completed as shown in FIG. 11. Thereafter, with the housing 20 lightly connected to the mating connector 90, the lever 60 is moved leftward with respect to the housing 20 from the temporary locking position to the complete locking position. When the lever 60 reaches the complete locking position, the operating portion 62 butts against the right end surface of the frame 21 (see FIG. 9) and the locking portions 68 are resiliently fit into the complete lock receiving portions 35 (see FIG. 12). In this way, the lever 60 is held in the state restricted from moving with respect to the housing 20. While the lever 60 is moving from the temporary locking position to the complete locking position, the moved guide portions 71 slide along the movement guide portions 32. When the lever 60 is at the complete locking position, the moved guide portion 71 is maintained in the state fit to the movement guide portion 32 and the cam body portion 65 is arranged in a state restricted from rattling in the front-rear direction and the vertical direction with respect to the lever accommodating portion 26 as shown in FIG. 10.

Further, when the lever 60 is at the complete locking position, the reinforcing portion 63 is in contact with the facing surface 23A, the cam body portion 65 is in contact with the contact surface 23B and an inclined portion 64 formed between the reinforcing portion 63 and the cam body portion 65 is in contact with the step surface 23C as shown in FIG. 9. In this way, the cam portion 61 is corrected from an inward deflected state to assume a horizontal posture and the cam portion 61 contacts the slide surface 23 while applying a resilient force, whereby the inward deflection of the cam portion 61 is corrected.

As described above, the connector 10 of this embodiment is provided with the housing 20 connectable to the mating connector 90 and the lever 60 for the connecting/separating operation movable in the lateral direction (sliding direction) intersecting the connection direction of the housing 20 and the mating connector 90 along the slide surfaces 23 of the housing 20. The housing 20 includes the lever accommodating portions 26 defining spaces for arranging the lever 60 between the lever accommodating portions 26 and the slide surfaces 23, the openings 31 facing the slide surfaces 23 on the right ends (one ends) of the lever accommodating portions 26, the movement guide portions 32 extending leftward from the openings 31 at the positions on the vertically outer sides separated from the slide surfaces 23 on the inner surfaces of the lever accommodating portions 26, and the assembly guide portions 25 projecting from the slide surfaces 23, extending rightward and facing the movement guide portions 32 at the positions corresponding to the openings 31.

According to this embodiment, even if the moved guide portion 71 of the lever 60 is shifted from the movement guide portion 32 of the housing 20 when the lever 60 is assembled with the housing 20, the moved guide portion 71 can be automatically brought to a position engageable with the movement guide portion 32 by sliding the lever 60 along the assembly guide portions 25. Thus, the operation of assembling the lever 60 with the housing 20 can be performed without any trouble.

Further, in the case of this embodiment, the assembly guide portions 25 extend in the lateral direction inside and outside the lever accommodating portion 26 via the opening 31. Thus, a movement stroke of the lever 60 along the assembly guide portions 25 can be ensured to be long, and reliability in bringing the lever 60 to the position engageable with the movement guide portions 32 can be enhanced.

Further, in the case of this embodiment, the lever 60 includes the pair of cam portions 61 extending in the lateral direction while facing each other in the vertical direction and the operating portion 62 coupling the cam portions 61. At the complete locking position, the cam portion 61 is in contact with the slide surface 23 while applying a resilient force. According to this, even if the cam portion 61 is deformed to be deflected inward with respect to the operating portion 62 during the molding of the lever 60, the inward deflection of the cam portion 61 can be corrected by the cam portion 61 contacting the slide surface 23.

Further, in the case of this embodiment, the lever 60 is arranged in proximity to the assembly guide portions 25 in a non-contact state at the complete locking position. Particularly, the reinforcing portion 63 of the lever 60 is contactably facing the rear part of the facing surface 23A and the assembly guide portions 25 are formed in the front part of the facing surface 23A. Thus, the assembly guide portions 25 can be provided with good space efficiency at a position (dead space) where interference with the lever 60 can be avoided.

Furthermore, in the case of this embodiment, the assembly guide portion 25 includes the guide slope 25A inclined toward the movement guide portion 32 from the slide surface 23 and extending in the sliding direction outside the lever accommodating portion 26. According to this, the lever 60 can be brought to the position engageable with the movement guide portion 32 with high reliability by being guided by the guide slope 25A. Further, since the guide slope 25A is located outside the lever accommodating portion 26 and easily processed, the formability (dimensional accuracy) of the guide slope 25A can be enhanced.

### Other Embodiments of Present Disclosure

The embodiment disclosed this time should be considered illustrative in all aspects, rather than restrictive.

In the case of the above embodiment, the movement guide portion 32 is provided by recessing the inner surface of the end wall portion 28 (front end wall portion 28A) of the lever accommodating portion 26. In contrast, according to another embodiment, a movement guide portion may be formed without having a special shape (convex or concave shape) on the inner surface of an end wall portion of a lever accommodating portion. Similarly, a moved guide portion may also be formed without having a special shape such as a rib shape.

In the case of the above embodiment, the housing 20 includes the frame 21 and the plurality of sub-housings and the frame 21 is provided with the assembly guide portions 25 and the movement guide portions 32. In contrast, according to another embodiment, a housing may be configured as an integrated housing capable of accommodating terminal fittings, and assembly guide portions and movement guide portions may be provided in the integrated housing.

In the case of the above embodiment, the cam body portion 65 of the lever 60 is arranged in contact with the slide surface 23 (contact surface 23B) of the frame 21 when the lever 60 is at the complete locking position. In contrast, according to another embodiment, when a lever is at a complete locking position, a cam body portion of the lever may be arranged to be lifted from a slide surface while being supported on a movement guide portion.

From the foregoing, it will be appreciated that various exemplary embodiments of the present disclosure have been described herein for purposes of illustration, and that various modifications may be made without departing from the scope and spirit of the present disclosure. Accordingly, the various exemplary embodiments disclosed herein are not intended to be limiting, with the true scope and spirit being indicated by the following claims.

What is claimed is:

1. A connector, comprising:
a housing connectable to a mating connector; and
a lever for connecting operation movable in a sliding direction intersecting a connection direction of the housing and the mating connector along a slide surface of the housing,
the housing including:
a lever accommodating portion defining a space for arranging the lever between the slide surface and the lever accommodating portion;
an opening facing the slide surface at one end of the lever accommodating portion;
a movement guide portion extending in the sliding direction from the opening at a position separated from the slide surface on an inner surface of the lever accommodating portion; and
an assembly guide portion projecting from the slide surface, extending in the sliding direction and facing the movement guide portion at a position corresponding to the opening.

2. The connector of claim 1, wherein the assembly guide portion extends in the sliding direction inside and outside the lever accommodating portion via the opening.

3. The connector of claim 1, wherein:
the lever includes a pair of cam portions facing each other and extending in the sliding direction and an operating portion coupling the cam portions and reaches a complete locking position with respect to the housing when connection of the housing and the mating connector is completed, and
the cam portion is in contact with the slide surface while applying a resilient force at the complete locking position.

4. The connector of claim 3, wherein the lever is arranged in proximity to the assembly guide portion in a non-contact state at the complete locking position.

5. The connector of claim 1, wherein the assembly guide portion includes a guide slope inclined toward the movement guide portion from the slide surface and extending in the sliding direction outside the lever accommodating portion.
